(19) United States
(12) Patent Application Publication
(10) Pub. No.: US 2005/0016210 A1
(43) Pub. Date: Jan. 27, 2005

(54) Wristwatch or bracelet with arm-grasping housing

(76) Inventors: David Weiss, Toronto (CA); Mitch Shore, Toronto (CA)

Correspondence Address: Mark B.Eisen;Dimock Stratton LLP, 20 Queen Street West, Suite 3202, Box 102, Toronto, ON, M5H 3R3, CA

(21) Appl. No.: 10/915,718

(22) Filed: Aug. 6, 2004

Related U.S. Application Data
(63) Continuation of application No. 10/273,255, filed on Oct. 18, 2002.

(51) Int. Cl. A44C 5/00; G04B 1/00; G04C 3/00

(52) U.S. Cl. 63/3

(57) ABSTRACT

The present invention provides a decorative wristwatch that is easy for the user to put on with one hand. The wristwatch comprises a decorative housing and opposing resilient armbands that are biased to a closed position and may be moved to an open position to apply or remove the wristwatch. In the preferred embodiment the housing is shaped in the form of an animal or character with opposed pairs of armbands being formed as appendages of the animal or character. A wristwatch according to the invention is accordingly fun to wear, fashionable, and easy for the user to engage to his or her wrist using only one hand.

### REFERENCE TO RELATED APPLICATIONS

This application is a continuation of U.S. patent application Ser. No. 10/273,255 filed Oct. 18, 2002.

### FIELD OF THE INVENTION

This invention relates to watches. In particular, this invention relates to a bracelet or wristwatch having a decorative housing with arm bands that grasp the arm of the user.

### BACKGROUND OF THE INVENTION

Wristwatches are worn by all segments of society. While to an adult the primary function of the wristwatch is to allow the user to determine the correct time, in many cases the wristwatch also serves an ornamental purpose.

Children in particular will often select a wristwatch for fashion reasons. In some cases a child will wear a watch primarily as a fashion item, and the convenience of having the correct time immediately accessible is either secondary or irrelevant. Children also tend to like a particular wristwatch because it is popular, but at the same time like to be able to wear an item that is somewhat distinctive. Bracelets can be fashionable for the same reasons.

A parent will often take comfort in knowing that the child is aware of the time and not reliant on others to apprise the child of the time day. To some extent this is a sign of responsibility in a child. Moreover, in the case of very young children it can be considered beneficial to introduce the child to the routine of wearing a wristwatch, or an alternative such as a bracelet, at an early age. It is accordingly advantageous to provide the child with a wristwatch or bracelet which is fashionable, fun to wear, and somewhat distinctive to satisfy most children's desire to “show off” a unique personal belonging.

Further, a wristwatch must be put on with one hand. The clasp of a conventional watchband can be difficult to manipulate with one hand, particularly for a child whose dexterity may not be fully developed. Accordingly, despite a parent's desire to coax their child into the routine of wearing a wristwatch, the child may be unable to put on the wristwatch because only one of the child's hands is available to operate the clasp, or the child may be frustrated when they encounter difficulty in doing so and may try to avoid wearing a watch.

It would accordingly be further advantageous to provide a wristwatch that is easy for a child to put on with one hand.

### SUMMARY OF THE INVENTION

The present invention provides a wristwatch or bracelet that is decorative, easy for the user to put on with one hand, and conducive to forming part of a thematic collection of many different styles. This provides an item for children to wear that is fashionable, but at the same time different users can possess different variations of the wristwatch or bracelet, all of which being thematically related to the collection.

The invention accomplishes this by providing a wristwatch or bracelet comprising a decorative housing and opposing resilient armbands that are biased to a closed position and may be pried to an open position to put on the wristwatch or remove the wristwatch from the user's arm.

the preferred embodiment, the housing according to the present invention presents opposed pairs of resilient armbands, and the housing is shaped in the form of an animal or character, real or fictitious, with the opposed pairs of armbands being formed as appendages of the animal or character. Thus, a wristwatch according to the invention is particularly suitable for marketing as a “collectible” item, i.e. part of a collection of wristwatches, being produced as part of a line of animals and/or characters, for example cartoon or comic strip characters, while providing a virtually unlimited variety of shapes and styles to thus allow users to collect and wear different variations of the wristwatch or bracelet.

A wristwatch or bracelet according to the invention is accordingly fun to wear, fashionable, and easy for the user to engage to his or her wrist using only one hand.

The present invention thus provides a housing for a wristwatch, comprising a body for mounting a timepiece, and at least two opposed armbands extending away from the body, at least one of the armbands being flexible and biased to an engaging position in which the armbands engage around a user's wrist and moveable between the engaging position and an open position, whereby when the user moves the armband to the open position the wristwatch can be engaged to the user's arm or disengaged from the user's arm.

The present invention further provides a wristwatch, comprising a timepiece, a body for mounting the timepiece, and at least two opposed armbands extending away from the body, at least one of the armbands comprising a resilient member biased to an engaging position in which the armbands engage around a user's wrist and moveable between the engaging position and an open position, whereby when the user moves the resilient member to the open position the wristwatch can be engaged to the user's arm or disengaged from the user's arm.

In further aspects of the invention: the body is shaped in the form of an animal or character; the armbands are shaped like appendages of the animal or a character; the housing comprises a first pair of armbands in opposition to a second pair of armbands; in which the armbands on at least one side of the user's arm comprise a core of a resilient material; both armbands are resilient and biased to the closed position; both pairs of armbands comprise a resilient member and are biased to the closed position; the housing comprises a plurality of armbands extending from each side of the body wherein all armbands comprise a resilient member and are biased to the closed position; the body is molded; and/or the resilient members are formed as part of an integral core insert and the armbands are molded over the core insert integrally with the body.

The present invention further provides a bracelet, comprising a body, and at least two opposed armbands extending away from the body, at least one of the armbands comprising a resilient member biased to an engaging position in which the armbands engage around a user's wrist and moveable between the engaging position and an open position, whereby when the user moves the resilient member to the open position the bracelet can be engaged to the user's arm or disengaged from the user's arm.

### BRIEF DESCRIPTION OF THE DRAWINGS

In drawings which illustrate by way of example only a preferred embodiment of the invention,

FIG. 1 is a perspective view of a first embodiment of a watch according to the invention;

FIG. 2A is a cross-sectional side elevation of the watch of FIG. 1;

FIG. 2B is a cross-sectional end elevation of the insert shown in FIG. 2;

FIGS. 3A, 3B, 3C, 3D and 3E are perspective views of different variations of the watch of FIG. 1, showing different animal and/or character shapes for the watch housing by way of non-limiting example; and

FIG. 4 is a perspective view of a bracelet according to the invention

### DETAILED DESCRIPTION OF THE INVENTION

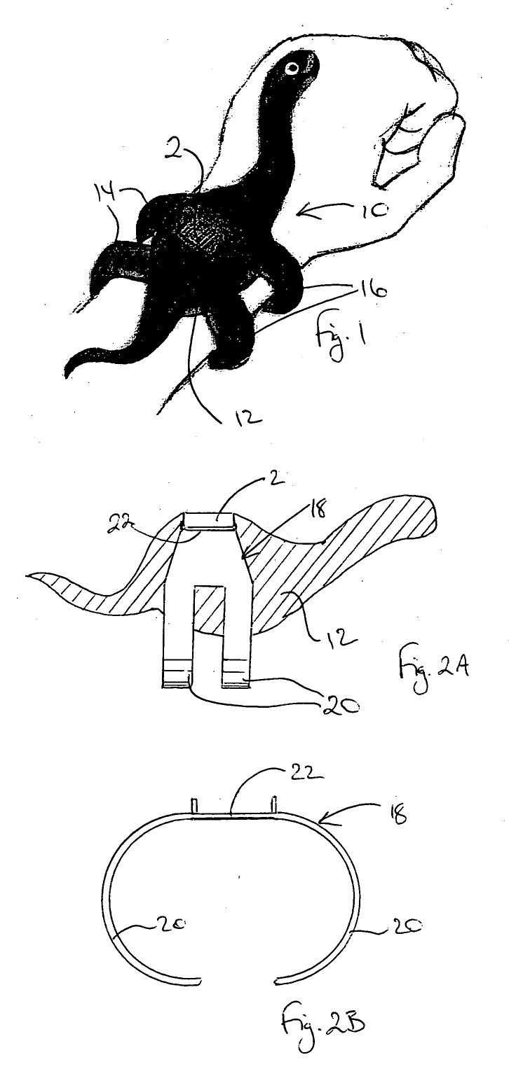

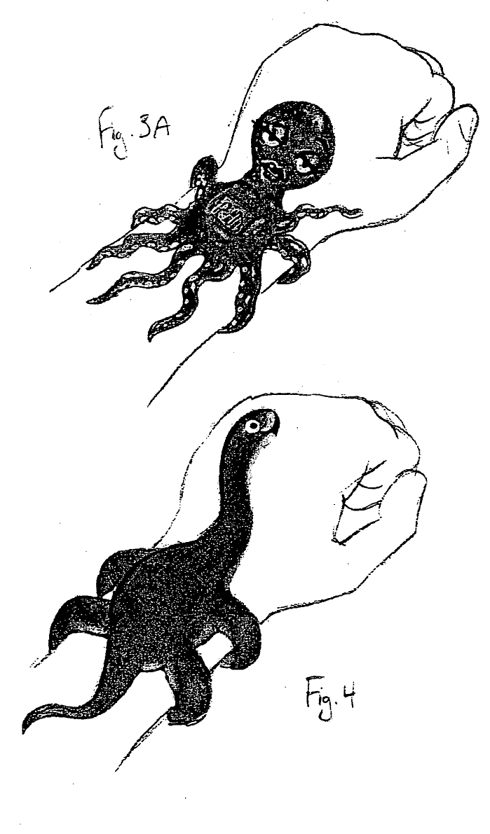

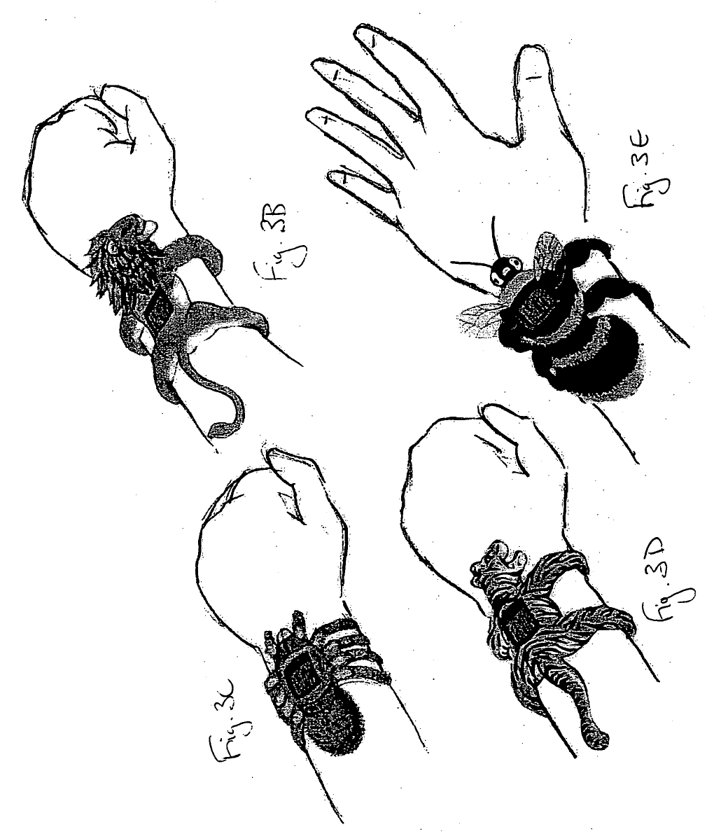

An embodiment of the wristwatch of the invention is illustrated in FIG. 1. It will be appreciated that the embodiment of FIG. 1 is merely one example out of a virtually infinite variety of wristwatch shapes and/or styles that can be produced according to the present invention.

The wristwatch comprises a timepiece 2 lodged in a housing 10, which in the preferred embodiment comprises a body 12 formed generally in the shape of an animal or character, which may be realistic or fictitious, for example a popular cartoon character. The body 12 illustrated in FIG. 1 by way of example only is in the form of a dinosaur body. The body 12 of the housing 10 may be formed, for example molded, from rubber, plastic, silicone or any other suitable material, flexible or rigid, and colored with any desired pigment, paint or otherwise to increase the realism of its appearance. The body 12 may alternatively be formed as a plush figure, made from any available fabric and stuffed in conventional fashion to maintain the body 12 in the desired shape.

The timepiece 2 may be embedded (in the case of a molded body 12) or sewn (in the case of a plush body 12) in any convenient position where it is visible to the user when the housing 10 is engaged to the user's wrist. The timepiece 2 shown in FIG. 1 by way of example is a conventional digital electronic timepiece, however any desired timepiece may be mounted or affixed to the housing 10 and the invention is not intended to be limited to any particular type of timepiece 2 associated with the watch housing 10.

Projecting from the body 12 are opposed armbands 14, 16. In the embodiment shown each watch is provided with a pair of armbands 14 and a pair of armbands 16, however a single armband 14 and a single opposing armband 16 will also operate effectively accordingly to the principles of the invention, although the wristwatch will not necessarily be as resistant to disengagement as where opposed pairs of armbands 14, 16 are used. Further, any number of additional armbands 14 and/or 16 may be included, either to accommodate the design of the animal or character (for example a spider with eight legs) or to increase the resistance to disengagement of the watch from the user's arm. In alternative embodiments the arm bands 14, 16 may be very wide, for example the wings of a bird (not shown) or the fins of a fish (not shown), in which case a single armband 14 and a single armband 16 may be preferable and just as stable.

The armbands 14, 16 are biased to a closed position, either permanently or selectively. For example, each armband 14, 16 may comprise a core of a spring member 20, for example composed of spring steel, which is formed in and thus permanently biased to the grasping position shown in solid lines in FIG. 1. The resistance to bending of the spring member 20 is a matter of selection, it being desirable that the wristwatch be held sufficiently firmly against the user's wrist so as not to disengage inadvertently, while at the same time the armbands 14, 16 should be sufficiently easy to bend as to permit a child to pry the bands 14 and/or 16 away from his or her arm fairly readily in order to apply or remove the wristwatch.

The arm bands 14, 16 may alternatively be rigid and pivotally mounted to the body 12, biased to an engaging or grasping position by a spring or other resilient element; or the arm bands 14, 16 may be flexible and formed from a material, or provided with a core of material, which retains its shape under sufficient force to resist disengagement from the user's arm. In each case at least one of the arms bands 14 or 16 is flexible and biased to the closed position.

The armbands 14, 16 may be formed separately from the body 12 and attached to the body 12 after fabrication. However, in the preferred embodiment an insert 18 comprising spring cores 20 for each of the armbands 14, 16 is formed as a single unit, visible in FIG. 2. The junction between the spring cores 20 may provide a backing plate 22 for the timepiece 2, for example with a rim 24 into which the timepiece 2 is mounted in snap-fit relation to prevent dislodgement.

Where the body 12 is molded, each spring core 20 (or the insert 18 comprising all spring cores 20 extending from backing plate 22) is preferably molded integrally with the body 12, and preferably fully encapsulated in the molding material so as to conceal any sharp edges. In the example illustrated in FIG. 1, the rubber body 12 is molded integrally with pairs of armbands 14, 16. The insert 18 comprising spring cores 20 and backing plate 22 is positioned in the mold in conventional fashion so as to be completely surrounded by rubber during the molding process (for example injection molding). Because the rubber is flexible, it does not significantly impede the resilience of the spring core 20 or the user's ability to pry the bands 14 and/or 16 apart to apply or remove the wristwatch.

The embodiment in which the spring cores 20 for the armbands 14, 16 are formed as a single-piece insert with the backing plate 22, is also particularly suitable for a plush version of the wristwatch according to the invention. Once the insert 18 has been die stamped (or otherwise cut out) and pressed (or otherwise formed) into the desired position, the orientations of the spring cores 20, and thus the wristbands 14, 16, are fixed by the backing plate 22 and so do not rely upon the material of the body 12 or filling material for structural strength. Moreover, the backing plate 22 provides a solid surface for mounting the timepiece 2.

To manufacture the molded embodiment of the invention, a core insert 18 comprising spring cores 20 for each of the armbands 14, 16 projecting from a backing plate 22 is placed in a mold (not shown) and secured in position within the mold by suitable spacing elements (not shown) in conventional fashion. A filler piece is positioned where the timepiece 2 will be mounted, to exclude molding material from the space that the timepiece 2 will occupy. Plastic, rubber or any other suitable molding material is injected into the mold and encapsulates the core insert 18. The housing 10 thus produced is removed from the mold and the timepiece 2 is mounted to the backing plate 22.

In this embodiment it may be advantageous to form the opening in which the timepiece 2 is mounted slightly smaller than the size of the timepiece 2, so that the resilient molding material will hold the timepiece 2 in position in the finished product. If the molding material is not resilient, other means (for example adhesive or mechanical structures) may be required to secure the timepiece 2 against dislodgement.

In use, the user positions one of his or her arms against the tips of one of the pairs of armbands 14 or 16, and pries the other pair of armbands 16 or 14 open so that the arm fits between the tips of the pairs of armbands 14, 16. When the user releases the armbands 14, 16 the resilient spring cores 20 draw the armbands 14, 16 back to the grasping position, engaging the wristwatch to the user's arm.

It will be appreciated that it is possible to form the spring cores 20 so as to lock in the open position, for example in the same fashion as a “slap bracelet”. This can be accomplished by forming each spring core 20 with a slight transverse curvature that must be straightened before the spring core 20 will bend longitudinally. Prying the spring core 20 open to a longitudinally straight position re-establishes the transverse curvature and locks the spring core 20 into a longitudinally straight position. This allows a user to pry the armbands 14, 16 to the open position, and then “slap” the wristwatch onto their wrist. The momentum of the open armbands suddenly stopping as the body 12 comes into contact with the user's wrist overcomes the stiffening effect of the transverse curvature and allows the spring cores 20 to return to the engaging position and grasp the user's arm.

It will also be appreciated that the principle of the invention applies even if the armbands 14 or 16 on only one side of the body 12 are resilient or flexible. In this case the armbands on the other side of the body, for example armbands 16, may be fixed and rigid while the armbands 14 are biased to the closed position but can be pried to the open position. Sufficient clearance will still be available for the user to insert his or her wrist between the armbands 14, 16.

Various embodiments of the present invention having been thus described in detail by way of example, it will be apparent to those skilled in the art that variations and modifications may be made without departing from the invention. The invention includes all such variations and modifications as fall within the scope of the appended claims.

1. A housing for a wristwatch, comprising
an integral core insert comprising a backing plate for mounting a timepiece and at least one resilient member extending from a side of the backing plate, and
at least two opposed armbands extending away from a body portion shaped in a form of an animal or character and molded around the backing plate, at least one of the armbands being molded over the at least one resilient member and biased to an engaging position for engaging around a user's wrist and moveable between the engaging position and an open position, the at least one of the armbands being molded over the core insert integrally with the body portion,
whereby when the user moves the at least one of the armbands molded over the resilient member to the open position the housing can be engaged to the user's arm or disengaged from the user's arm.

2. The housing of claim 1 wherein the armbands are shaped like appendages of the animal or the character.

3. The housing of claim 2 comprising a first pair of armbands in opposition to a second pair of armbands.

4. The housing of claim 3 in which the armbands on both sides of the body comprise a core of a resilient material.

5. The housing of claim 1 in which both armbands are flexible and biased to a closed position.

6. The housing of claim 3 in which both pairs of armbands comprise a resilient member and are biased to a closed position.

7. The housing of claim 1 comprising a plurality of armbands extending from each side of the body wherein all armbands comprise a resilient member and are biased to a closed position.

8. A wristwatch, comprising
a timepiece,
an integral core insert comprising a backing plate for mounting a timepiece and at least one resilient member extending from a side of the backing plate, and
at least two opposed armbands extending away from a body portion shaped in a form of an animal or character and molded around the backing plate, at least one of the armbands being molded over the at least one resilient member and biased to an engaging position for engaging around a user's wrist and moveable between the engaging position and an open position, the at least one of the armbands being molded over the core insert integrally with the body portion,
whereby when the user moves the resilient member to the open position the wristwatch can be engaged to the user's arm or disengaged from the user's arm.

9. The wristwatch of claim 8 wherein the armbands are shaped like appendages of the animal or the character.

10. The wristwatch of claim 9 comprising a first pair of armbands in opposition to a second pair of armbands.

11. The wristwatch of claim 10 in which the armbands on both sides of the body comprise a core of a resilient material.

12. The wristwatch of claim 8 in which both armbands are resilient and biased to a closed position.

13. The wristwatch of claim 10 in which both pairs of armbands comprise a resilient member and are biased to a closed position.

14. The wristwatch of claim 8 comprising a plurality of armbands extending from each side of the body wherein all armbands comprise a resilient member and are biased to a closed position.

15. A bracelet, comprising
an integral core insert comprising a backing plate and at least one resilient member extending from a side of the backing plate, and
at least two opposed armbands extending away from a body portion shaped in a form of an animal or character and molded around the backing plate, at least one of the armbands being molded over the at least one resilient member and biased to an engaging position for engaging around a user's wrist and moveable between the engaging position and an open position, the at least one of the armbands being molded over the core insert integrally with the body portion,
whereby when the user moves the at least one resilient member to the open position the bracelet can be engaged to or disengaged from a user's arm.

16. The bracelet of claim 15 wherein the armbands are shaped like appendages of the animal or the character.

17. The bracelet of claim 16 comprising a first pair of armbands in opposition to a second pair of armbands.

18. The bracelet of claim 17 in which the armbands on both sides of the body comprise a core of a resilient material.

19. The bracelet of claim 18 in which both pairs of armbands comprise a resilient member and are biased to a closed position.

20. The bracelet of claim 15 comprising a plurality of armbands extending from each side of the body, wherein all armbands comprise a resilient member and are biased to a closed position.
